(19) United States
(12) Patent Application Publication
(10) Pub. No.: US 2016/0036865 A1
(43) Pub. Date: Feb. 4, 2016

(54) METHOD AND SYSTEM FOR ESTABLISHING COMMUNICATION

(71) Applicant: RAMESH BASWA, HYDERABAD (IN)

(72) Inventor: RAMESH BASWA, HYDERABAD (IN)

(21) Appl. No.: 14/815,279

(22) Filed: Jul. 31, 2015

(30) Foreign Application Priority Data
Jul. 31, 2014 (IN) 3761/CHE/2014

(51) Int. Cl. H04L 29/06

(52) U.S. Cl. CPC H04L 65/1069

(57) ABSTRACT

Systems and method for establishing communication between two entities are disclosed. The method comprises, establishing connection between two entities upon accepting request, providing an option to make a communication group be one of private or public, such that the communication in a private groups is confined only to two entities, sending messages to the communication groups using a messenger by one or more enterprises and recommending one or more channels to a user and the enterprise.

### CROSS-REFERENCE TO RELATED APPLICATION

The present application claims priority under 35 U.S.C. 119(a) to India (IN) patent application number 3761/CHE/2014 filed Jul. 31, 2014, which is incorporated herein by reference in its entirety.

### FIELD OF INVENTION

The present invention relates to field of electronic communication and in particular, the invention relates to establishing electronic communication between two entities.

### BACKGROUND

Instant messaging (“IM”) provides a form of real-time communications based on text messages exchanged between users. Users can exchange instant messages between computers, cell phones, PDAs and other wired or wireless devices. Instant messaging sessions are almost exclusively carried out by users using either a computer or a cell phone. The text that is exchanged is transmitted over an intermediate network, such as the Internet. Some IM applications can use push technology to provide real-time text, which transmits messages character by character, as they are composed. More advanced instant messaging can add short-messaging service (SMS), file transfer, clickable hyperlinks, and video chat.

Instant messaging systems tend to facilitate connections between specified known users (often using a contact list also known as a “buddy list” or “friend list”). Depending on the IM protocol, the technical architecture can be peer-to-peer or client-server network.

Conventional systems have limited single enterprise and users associated with the enterprise to receive messages. Enterprises has to opt for such enterprise communication tools on their knowledge and interests and having limited scope of user base. This conventional system is not desirable for both enterprises and user base as this limits the scope of collaborations and business expansions.

In light of the above discussion, there is a need for a method that overcomes the above disadvantages.

### BRIEF DESCRIPTION OF FIGURES

FIG. 1 illustrates environment in which a business intelligence messenger works, in accordance with various embodiments of the present invention;

FIG. 2 illustrates a block diagram of a functional architecture of the business messenger, in accordance with various embodiments of the present invention;

FIG. 3 illustrates components of business intelligence messenger, in accordance with various embodiments of the present invention;

FIG. 4 illustrates a flowchart for establishing connections between two entities, accordance with various embodiments of the present invention; and

FIG. 5 illustrates a block diagram of a computer server system, in accordance with various embodiments of the present invention.

### BRIEF DESCRIPTION OF THE INVENTION

The above-mentioned shortcomings, disadvantages and problems are addressed herein which will be understood by reading and understanding the following specification.

A method for establishing a communication between two entities by a platform is described here. The method includes establishing connection between one or more entities, wherein the entities can be one of an individual, a group and an enterprise. The connection is established after accepting the request and the one or more entities are provided with log in credentials. The method also includes, providing an option to make a communication group be one of private or public, such that the communication in a private groups is confined only to two entities. Furthermore, the method includes sending messages to the communication groups using a messenger by, wherein the messenger sends messages to communication groups by combining the ecosystem of the enterprises and individuals in a user group, determining the relationship between the enterprises' messages and the individuals' interest to obtain business intelligence related to the enterprise and communicating in one or more languages.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

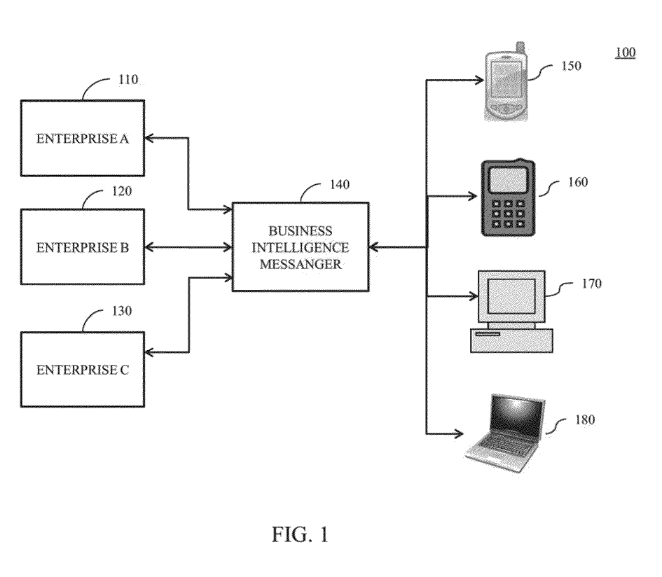

FIG. 1 illustrates environment 100 in which a business intelligence messenger works, in accordance with various embodiments of the present invention. The environment 100 includes an entity,an enterprise A 110, an enterprise B 120, an enterprise C130. In an embodiment, the enterprise A 110, the enterprise B 120, and the enterprise C 130 can be an entity such as business firm that wants to communicate with other entity. In another embodiment, the enterprise A 110, the enterprise B 120, and the enterprise C 130 can be separate individual entities. The enterprise A 110, the enterprise B 120 and the enterprise C 130 communicates with other entities by sending one or more messages.

The environment 100 comprises of a business intelligence messenger 140 (herein after referred to as BIM). The BIM 140 is a messenger that sends messages to one or more entities through one or more entities. The BIM 140 establishes communication between two entities. In an embodiment, the one of one or more entities can be an enterprise owner and the other can be an individual. In another embodiment, the two entities can be enterprises. The BIM 140 has intelligence that can recommend channels to one or more entities.

The environment 100 includes a computing device 150, a computing device 160, a computing device 170, and a computing device 180. In an embodiment, the computing device 150 is a smart phone, the computing device 160is a phone having the capability to receive a SMS, the computing device 170 is a desktop computer and the computing device 180 is a laptop computer. In another embodiment, the computing devices 150, 160, 170 and 180 can be internet connectable devices. Examples of internet connectable device 105 can be a personal computer, laptop, smart-phone, tablets, personal digital assistants (PDA), gaming console, television and the like.

In the environment 100, the messages can be sent to the enterprise 110, the enterprise 120 and the enterprise 130 by the computing device 150, the computing device 160, the computing device 170 and the computing device 180and vice versa by using the business intelligence messenger 140. For sending messages from one entity to another entity, the two entities (the entity sending messages and the entity receiving messages) should have subscribed for the platform that provides business intelligence messenger 140. The subscription can be obtained by registering and logging in into the platform that provides business intelligence messenger 140 or by downloading software, which provides a business intelligence messenger 140.

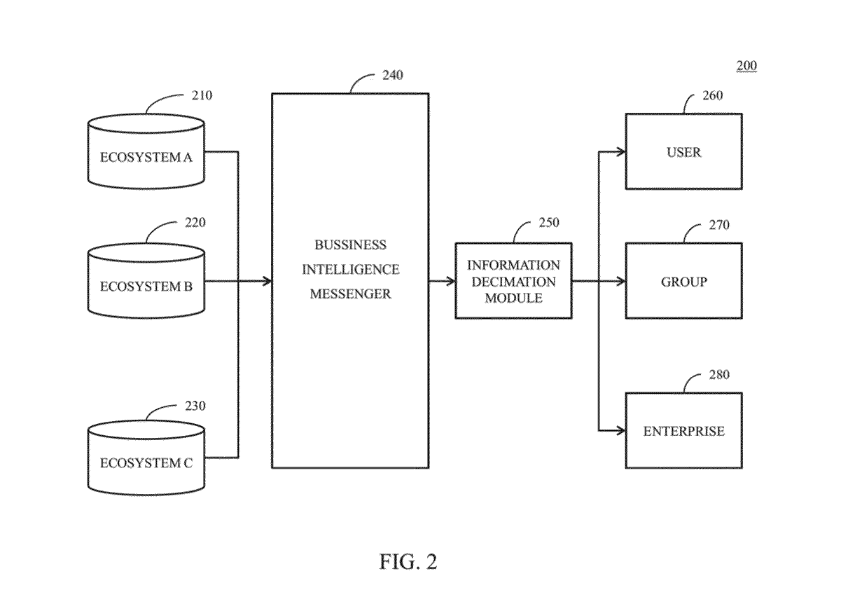

FIG. 2 illustrates a block diagram 200 of a functional architecture of the business messenger, in accordance with various embodiments of the present invention. FIG. 2 includes an ecosystem A 210, an ecosystem B 220 and an ecosystem C 230. The ecosystems are the systems which contain information about a particular domain. For example, the ecosystems can be agricultural ecosystem, technology ecosystem, scientific ecosystem, fashion ecosystem, story ecosystem and the like. The information present in one or more ecosystems are provided by anyone using internet by tagging appropriate domains.

FIG. 2 includes a business intelligence module 240 for channelizing the appropriate information from one entity to another entity using intelligence. In an embodiment, the business intelligence module 240 and the business intelligence module 140 are the same. In another embodiment, the business intelligence module 240 and the business intelligent module 140 are different from each other. The business intelligent module 240 can be used by the enterprise A 110, the enterprise B 120, the enterprise C 130 if they are associated with one of the ecosystem 210, the ecosystem 220 and the ecosystem 230 to communicate with the computing device 150,the computing device 160, the computing device 170 and the computing device 180. Further, the business intelligence module 240allows the enterprise A 110, the enterprise B 120 and the enterprise C 130 to communicate with the computing device 150,the computing device 160, the computing device 170 and the computing device 180 either privately or publicly through the ecosystem A 210,the ecosystem B 220 and the ecosystem C 230. The enterprise A 110, the enterprise B 120 and the enterprise C 130 can choose the option of sending messages either privately or publicly. A private message, for example can be an update of the enterprise A 110 that has created the ecosystem A 210 to all its employees who are the subscribers of the ecosystem A 210. A public message, for example can be an announcement of the upcoming product from the enterprise B 120, through the ecosystem B 220. The subscribers of the ecosystem B 120 can view the messages communicated by the enterprise A 110.

Further, the messages can be sent to one of computing devices in one or more languages. For example, the message from the enterprise A 110 can be sent to the computing device 150 through the ecosystem A 210 in English language. In another example, the message from the enterprise B 120 can be sent to the computing device 160 through the ecosystem B 220 in Kannada language. In yet another example, the message from the enterprise B 120 can be sent to the computing device 160 through the ecosystem B 220 in Malayalam language.

Further, the business intelligence messenger 240 recommends one or more entities, which can be subscribed by one or more enterprises. The recommendation is based on the data collected by the business intelligence messenger 240.

FIG. 2 further includes an information decimation module 250. The information decimation module 250 dissipates the information in an organized manner to one or more entities using the business intelligence messenger 240. Further, the information decimation module 250 will filter the unwanted and useless messages and reports to the business intelligence messenger 240.

FIG. 2 further includes a user 260, a group 270 and an enterprise 280. In an embodiment, the user 260, the group 270 and the enterprise are the entities that can communicate with each other. The user 260 is an individual who has subscribed to one of the enterprise A 110, the enterprise B 120 and the enterprise C 130 or all of them. The group is 270 is to share information with the small group of subscribers. The group 270 can be a family group, teammate group, start-up group, co-worker group and the like. The group 270 is created by a group owner. The group 270 can have one or more administrators who can add one or more subscribers to the group. Further, the group members can be removed by the group administrators. The group 270 can share information in the form of text, multimedia, document form and the like. In an embodiment, the group 270 may have group limit i.e., the number of members in the group. In another embodiment, the group 270 may not have any group limit i.e., the number of subscribers for that group is unlimited. Furthermore, the group 270 can be a secret, a public or a private group.

The enterprise 280 is an entity, which can share the updates of the enterprise. The enterprise 280 can be handled by a single administrator or one or more administrators. The updates shared by the enterprise 280 can be tagged with the relevant tags so that they belong to one of the ecosystem A 210, the ecosystem B 220 and the ecosystem C 230 or all of them. The enterprise 280 can share the updates of the enterprise using a private cloud-computing platform subscription or using the public cloud-computing platform subscription provided by the service provider of the business intelligence messenger 240. The private cloud-computing subscription platform will allow the enterprise 280to have additional and enhanced features. These additional features can include enhanced security, additional space for storing user data, reduced restrictions, 24*7 client support, unlimited updates and the like. The enterprise choosing for the private cloud-computing platform subscription may further have an option to track the user 260 using the demographic details provided by the computing device 150 or the computing device 160 or the computing device 170 or the computing device 180. The user 260 can be tracked using one or more demographic details. The demographic details include but are not limited to Global Positioning System (GPS), Assisted Global Positing System, Location Based Systems (LBS), Hybrid Positioning systems, network based identification, identifying the demographic details based on the browsing pattern, identifying the demographic details based on the cookies sent by the third-party server and the like.

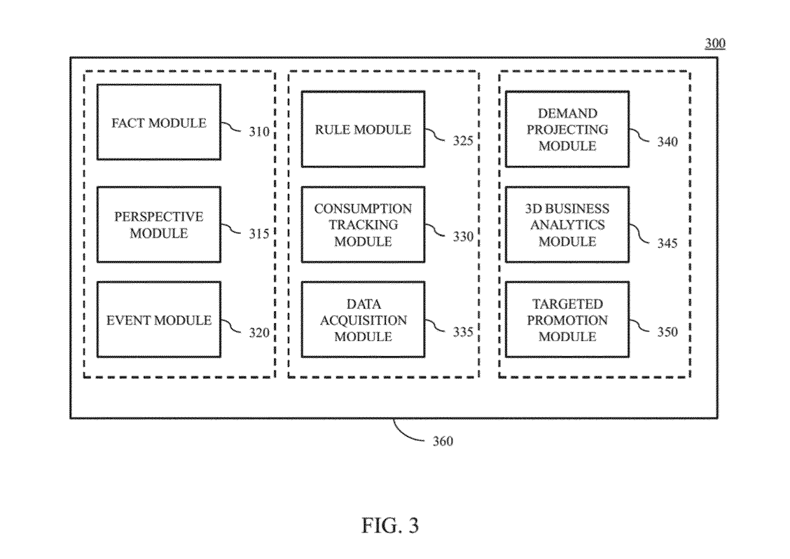

FIG. 3 illustrates components of business intelligence messenger, in accordance with various embodiments of the present invention. The business intelligence messenger 240 and the business intelligence messenger 360 are the same. The components of the business intelligence messenger include a fact module 310. The fact module 310 is a database of the basic transactional data in the numeric form. Fact module 310 is the database that stores the basic facts of one or more ecosystems that are unorganized. The facts comprises of the data, which can be parsed and can be tagged in one or more ecosystems. Further, the FIG. 3 includes an perspective module 315. The perspective module 315 provides the context of the user 260, the group 270 and the enterprise 280 to the facts making it useful piece of information. Further, the FIG. 3 includes an event module 320. The event module 320 analyzes the triggering points for various information processing activities. The analysis of the triggering points can be based on the statistical methods such as time-series method. Further, the FIG. 3 includes a rule module 325. The rule module 325 decides the conditions and the algorithms for data processing. The rule module 325 defines the relations between facts, events and perspective.

The business intelligence module 360includes a data acquisition module 335. The data acquisition module 335acquires the required data from both user end and the ecosystem for providing efficient and effective channel recommendation. The data acquisition module 335 captures the data from the user end by various methods. In an embodiment, the data acquisition module 335first captures the user needs. The user needs include the brand name, specific purpose (For example, Sports news from Nike®), location of the user and the like. In an embodiment, the user preference information and the user needs are the same. In another embodiment, the user preference information and the user needs are separate and are stored in different databases of the fact module 310. Once the user need is captured, the data acquisition module 335tracks the user needs and scans through the fact module 310 to recommend one or more ecosystems. Further, the data acquisition module 335 asks or questions the user 260, the group 270 and the enterprise 280 for improving the quality of the recommendation service. The questions to be asked to the user 260, the group 270 and the enterprise 280 are pre-loaded in the database of business intelligence messenger 360. In an embodiment, the questions asked by the business intelligence messenger 360 are objective questions. For example, the data acquisition module 335 in the business intelligence messenger 360 can ask questions to the user 115 such as “Do you prefer Bollywood movies or Hollywood movies?” who has entered movies as a preference. The questions can also include the location details such as “Can you tell us where you stay?” The questions answered by the user 260, the group 270 and the enterprise 280 are stored as user preference information and are used for improving the recommendation service. Furthermore, the data acquisition module 335 monitors the pattern in which the user 260, the group 270 and the enterprise 280 is entering the user preference information and recommends the appropriate ecosystem that matches the need.

The business intelligence messenger 360 includes a selection-tracking module 330. The selection-tracking module 330 tracks the selection of the recommended ecosystems using a data recorder (not shown in the figure). Selection tracking is a feature used for enterprises where frequent updates are required and that are based on company policies. The selection-tracking module 330 uses the pattern in which the group and the user selects the recommended channel as a proxy to manage recommendations. The selection behavior captured by selection-tracking module 330 also provides valuable insights about traits of the users and the groups.

Furthermore, the business intelligence messenger 360 includes a demand-projecting module 340. The demand-projecting module 360 projects the existing trend and the demand for the recommended one or more ecosystems. The demand-projecting module 360 also projects the demand and the trend of the recommended channel.

Furthermore, the business intelligence messenger 360 includes a 3D business analytics module 345. The 3D business analytics module 345analyzes the business model in time-domain. The 3D business analytics module 345 allows the recommendation pattern to be tracked in the three-dimensional space where identity and need can be tracked on a time-domain.

Furthermore, the business intelligence messenger 360 includes a targeted promotion module 350. The targeted promotion module 350 helps the business intelligence messenger 360 to target the right set of users with right set of recommendations. For example, the targeted promotion module 350 can target the online shopping channels to youths.

Additionally, the components in the business intelligence messenger 360 are coupled to each other for generating effective and efficient channel recommendation. For example, the business intelligence messenger 360 recommends one or more sports channel based on the defining features of the user, user preference information provided by the user 260, the group 270 and the enterprise 280.

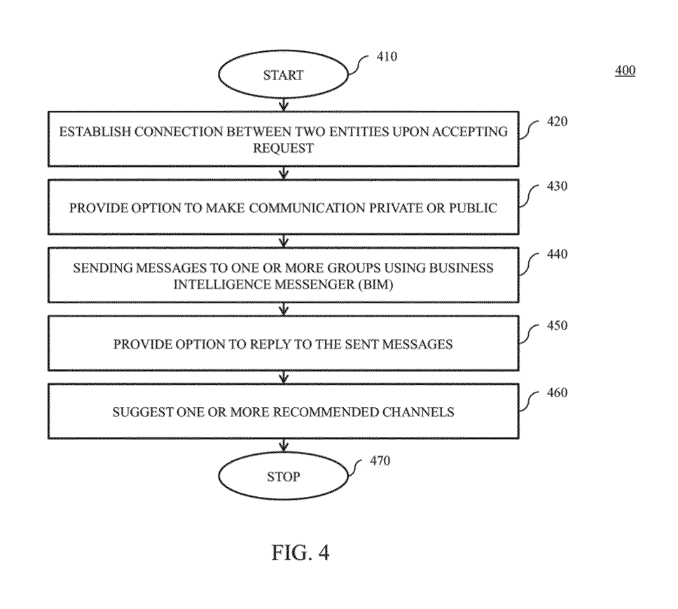

FIG. 4 illustrates a flowchart 400 for in establishing connections between two entities, accordance with various embodiments of the present invention. The flowchart initiates at step 410. At step 420, a connection is established between two entities. The connection can be between the user 260 and the enterprise 280 or the user 260 and the group 270 or between the group 270 and the enterprise 280 which are considered as entities. The connection is established when these entities are authenticated by the business intelligence messenger 240. For establishing connection, the entities have to first log in to the service provider offering the service using the business intelligence messenger 240. The service provider offering the service using the business intelligence messenger 240 is a third-party platform. In an embodiment, the third-party platform is a cloud-computing platform that enables Software as a Service (SaaS). The third-party platform offering the service of business intelligence messenger 240 may have the capability to collaborate plurality of operating systems and plurality of the frameworks. The third-party platform controls the software deployment and the configuration of the business intelligence messenger 240. In an embodiment, the logging in for sending messages using the business intelligence messenger 240 can be done by accessing internet using the computing device 150 or the computing device 160 or the computing device 170 or the computing device 180. In another embodiment, the logging in for sending messages using the business intelligence messenger 240 by integrating the software provided by the service provider of the business intelligence messenger 240. In an embodiment, the business intelligence messenger 240 provides the user name and the password for the user 260, the group 270 and the enterprise 280. In another embodiment, the business intelligence messenger 240 allows the user 260, the group 270 and the enterprise 280 to choose their username and password. The entity (the user 260, the group 270 and the enterprise 280) that wants to establish connection can contact the other entity. The other entity (the user 260, the group 270 and the enterprise 280) can accept or reject to establish connection. In an embodiment, the connection can be established by sending a request. Once the connection is established between two entities, the updates shared by the entity can be viewed. The updates may include but not limited to brief details, case studies, testimonials, multimedia messages and the like. The updates can be viewed by both logging into the account using internet or by the software downloaded by the computing device 150 or the computing device 160 or the computing device 170 or the computing device 180.

The connection between one or more entities (user to user, user to group, user to enterprise, group to group, enterprise to enterprise and vice-versa) is established using a communication link. For example, the communications links may communicate using HTTP and/or JABBER protocols. Moreover, any application layer protocol may be used. The communication links may be open links. An open link is an established link permitting data to flow from source to destination without requiring either the client or the server to request data for transmission. Open connections may be maintained by sending status packets or queries between the server and the client. The connection links may occur over the Internet, over an intranet or over any other type of communication network.

Once the entity(the user 260, the group 270 and the enterprise 280) accepts the request to establish connection, an option is provided to make the communication either public or private at the step 430. If the communication is made public, all the messages, multimedia messages and the files shared can be seen publicly. If the entities choose to make the communication between them private, the general subscribers may not be able to view the conversation between the two entities.

At step 440, the entities can send messages to one other using the business intelligence messenger 240. The messages can be in the form of text messages, multimedia media messages, document format, image format and the like. The messages when sent in the form of text can be sent in one or more languages. The enterprise A 110 updates the message using its log in credentials and tags that message in particular ecosystem, say ecosystem A 210. The user 260, the group 270 and the enterprise 280 will get messages updated by the enterprise A 110, if they have established connection with enterprise A 110. Further, the enterprise A 110 can communicate with the user not subscribed to service provided by the business intelligence messenger 240 by using short-messenger service (SMS). The user 260, the group 270 and the enterprise 280 can message through the business intelligence messenger 240 using any of the devices. The device can include but are not limited to mobile phone, laptop, desktop, tablet and the like. In an embodiment, the messages sent user 260, the group 270 and the enterprise 280 can have a word limit. For example, the word limit in one message can be 2000 words. In another embodiment, there may not be any word limit to the messages sent. Further, the messages can be sent in one or more languages including the local vernacular languages of the user. In yet another embodiment, the enterprise 280 can communicate multimedia content such as but not limited to audio clips, video clips, animations, GIFs.

At step 450, the business intelligence messenger 240 provides an option for the entities to reply for the messages received. The reply to the messages received can be made in one or more ways. In an embodiment, the reply can be sent publicly to the public message. In another embodiment, the reply can be sent privately to the public message. In yet another embodiment, the reply can be sent via a short-messaging service.

At step 460, after the user 260, the group 270 and the enterprise 280 chooses to reply to the messages, one or more ecosystems are recommended by the business intelligence messenger 240. The recommendation is done as described in the FIG. 3. The flowchart terminates at step 470.

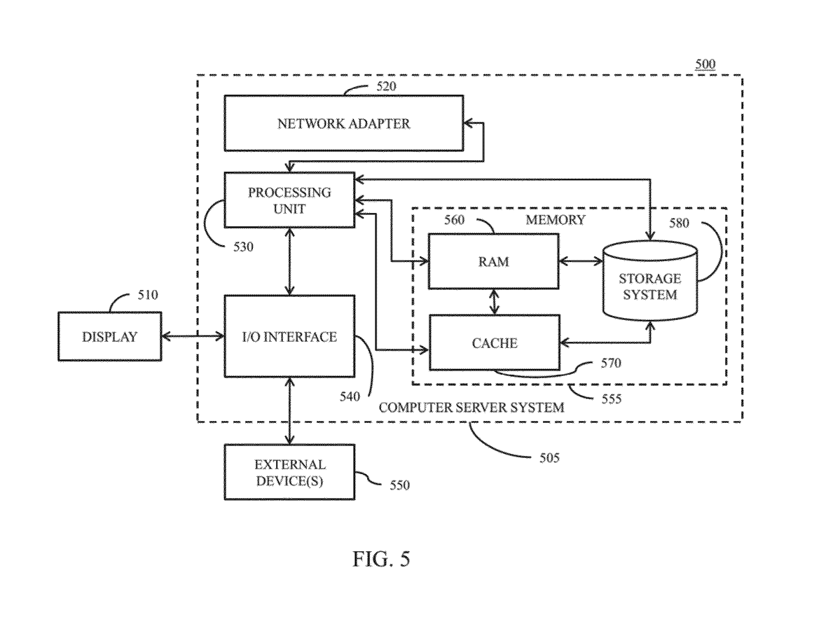

FIG. 5 illustrates a block diagram of a computer node 500 of the business intelligence messenger 240, in accordance with various embodiments of the present invention. The computer node 500 of the business intelligence messenger 240includes a computer server 505 that is operational with numerous other general purpose or special purpose computing system environments or configurations. Examples of well-known computing systems, environments, and/or configurations that may be suitable for use with computer server 505 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and the like.

In FIG. 5, the computer server 505 in the computer node 500 of the business intelligence messenger 240 is shown in the form of a general-purpose computing device. The components of computer server 505 include, but are not limited to, processing unit 530, a system memory 555, a network adapter 520, an input-output (I/O) interface 540 and one or more buses that couples various system components to processing unit 530.

The one or more buses represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer server 505 typically includes a variety of computer system readable media. Such media may be any available media that is accessible by computer server 505, and includes both volatile and non-volatile media, removable and non-removable media. In an embodiment, the system memory 555 includes computer system readable media in the form of volatile memory, such as random access memory (RAM) 560 and cache memory 570. Computer server 505 may further include other removable/non-removable, non-volatile computer system storage media. In an embodiment, the system memory 555 includes a storage system 580.

Computer server 505 can communicate with one or more external devices 550 and a display 510, via input-output (I/O) interfaces 540. In addition, computer server 505 can communicate with one or more networks such as a local area network (LAN), a general wide area network (WAN), and/or a public network (for example, the Internet) via the network adapter 520.

It can be understood by one skilled in the art that although not shown, other hardware and/or software components can be used in conjunction with the computer server 505. Examples, include, but are not limited to microcode, device drivers, redundant processing units, external disk drive arrays, RAID systems, tape drives, data archival storage systems, and the like.

The advantage of using the business intelligence messenger 240 for establishing communication between two entities is that this system is intelligence driven. Further, the messages can have one or more versions. For example, one version can be Indian version and the other is international version. Furthermore, the entities can have the option of sending messages instantaneously or the entities can schedule the messages to be sent at the defined date and time. In an embodiment, the messages sent by one or more entities are stores in the cloud-computing platform of business intelligence messenger 240 for the reasons of security. In another embodiment, the messages sent by one or more entities are not stored in the business intelligence messenger 240.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method for establishing a communication between two entities by a platform, the method comprising:
a. establishing connection between two entities upon accepting request, wherein the two entities are one of an enterprise and an individual;
b. providing an option to make a communication group be one of private or public, such that the communication in a private groups is confined only to two entities;
c. sending messages to the communication groups using a messenger by one or more enterprises, wherein the messenger sends messages to communication groups by:
a. combining the ecosystem of the enterprises and individuals in a user group;
b. determining the relationship between the enterprises' messages and the individuals' interest to obtain business intelligence related to the enterprise; and
c. communicating in one or more languages.

2. The method of claim 1 further comprising providing an option to the individuals in the communication groups to reply to the received messages.

3. The method of claim 1, wherein the communication between two entities is established by a third-party platform.

4. The method of claim 1, wherein the communication messages exchanged between one or more entities is stored in a server.

5. The method of claim 3, wherein the third-party platform allows the enterprises to receive one or more demographic details of the user.

6. A system for establishing communication between two entities, the system comprising:
a. a database for storing the information about the entities;
b. an information decimation module for channelizing the information to one or more devices; and
c. a messenger to deliver messages to one or more entities using one or more rules.
